(19) United States
(12) Patent Application Publication
(10) Pub. No.: US 2024/0409715 A1
(43) Pub. Date: Dec. 12, 2024

(54) FLUOROELASTOMER COMPOSITION

(71) Applicant: SOLVAY SPECIALTY POLYMERS ITALY S.P.A., Bollate (Milano) (IT)

(72) Inventors: Stefano Bossolo, Parabiago (IT); Andrea Montalbetti, Tradate (IT)

(73) Assignee: SOLVAY SPECIALTY POLYMERS ITALY S.P.A., Bollate (Milano) (IT)

(21) Appl. No.: 18/701,408

(22) PCT Filed: Oct. 6, 2022
(86) PCT No.: PCT/EP2022/077792

§ 371 Date: Apr. 15, 2024

(30) Foreign Application Priority Data
Oct. 14, 2021 (EP) 21202584.5

(51) Int. Cl. C08K 5/42; C08K 3/04; C08K 3/22

(52) U.S. Cl. CPC C08K 5/42; C08K 3/04; C08K 3/22; C08K 2003/2206; C08K 2003/2217

(57) ABSTRACT

The invention relates to a fluoroelastomer curable composition, to a method for curing the same, and to cured articles derived there from.

This application claims priority from European patent application Nr 21202584.5 filed on Oct. 14, 2021, the whole content of which is incorporated herein by reference for all purposes.

### TECHNICAL FIELD

The invention relates to a fluoroelastomer curable composition, to a method for curing the same, and to cured articles derived there from.

### BACKGROUND ART

Vulcanized fluoroelastomers have been used in a variety of applications, in particular for manufacturing sealing articles such as oil seals, gaskets, shaft seals and O-rings, because of several desirable properties such as heat resistance, chemical resistance, weatherability, etc.

It is nevertheless required for “as polymerized” fluoroelastomers to undergo curing/crosslinking processes (so-called “vulcanization”) in order to ensure required sealing and mechanical properties to be exhibited in final parts.

Several techniques have been developed for ensuring creation of a three-dimensional cured structure able to deliver expected performances. The underlying chemistry generally requires a crosslinking agent to provide for connections between fluoroelastomer polymer chains. Nature and reactivity of the crosslinking agents used enable categorizing cross-linking systems. The most widely used systems are based either on polyhydroxyaromatic compounds (typically bis-phenols), reacting through “ionic” chemistry in the presence of basic compounds and onium accelerators, via displacement of acidic hydrogen atoms in the chain, or on poly-unsatured compounds, reacting via radical chemistry in the presence of peroxide(s), via displacement of labile groups (typically iodine or bromine atoms) in the chain.

While it is acknowledged that overall performances of the fluoroelastomers will depend upon the nature, molecular structure and composition of the fluoroelastomer itself, it is nevertheless true that chemistry of cross-linking may have a significant impact on the same. Hence, there is a continuous quest in the art for alternative and improved crosslinking system, based on alternative chemistry, delivering outstanding cross linking ability and hence sealing performances in cured parts, being hence safer and cheaper than the above, and which could obviate to the drawbacks of the ionic or peroxide cross-linking systems of the prior art.

Among the others, WO 2016/180660 (published on 17 Nov. 2016 in the name of Solvay Specialty Polymers Italy S.p.A.) discloses a fluoroelastomer composition comprising at least one fluoroelastomer (A), at least one base (B), at least one pyridinium-type salt (P) having at least two groups in ortho or para position to the quaternized nitrogen atom bearing a reactive hydrogen. This patent application discloses several pyridinium-type salts comprising an aromatic ring-quaternized nitrogen atom that is salified in particular with p-toluensulphonate.

More recently, the above mentioned pyridiunium salts (P) have been disclosed in WO 2020/188125 (published on 24 Sep. 2020 in the name of Solvay Specialty Polymers Italy S.p.A.) as ingredient in a fluoroelastomer composition for bis-phenol curing, and as being useful to provide excellent molding and demolding performances, with high yield and substantially no mold fouling, significantly reducing blisters and flashes.

### SUMMARY OF INVENTION

The Applicant noted that the curing performance of (per)fluoroelastomer compositions comprising the at least one pyridinium-type salt (P) having at least two groups in ortho or para position to the quaternized nitrogen atom bearing a reactive hydrogen disclosed in the above patent applications are not optimal for the manufacture of cured articles via injection molding.

Without being bound by any theory, the Applicant noted that the elastomer compositions disclosed notably in WO 2016/180660 cited above showed a too fast torque increase at the beginning of the injection molding process, which was undesired for an optimal curing process.

Hence, facing the technical problem of improving the citing process when using (per)fluoroelastomer compositions comprising the at least one pyridinium-type salt, the Applicant surprisingly found that a composition comprising an organic aromatic acid in a selected amount allowed to control, more precisely to slow down, the torque increase at the beginning of the injection molding process, thus improving the curing process and providing a cured elastomer composition with good mechanical properties.

Thus, in a first embodiment, the present invention relates to a fluoroelastomer composition [composition (C)] comprising:
at least one vinylidene-fluoride based fluoroelastomer comprising recurring units derived from vinylidene fluoride (VDF) and from at least one additional (per)fluorinated monomer different from VDF [fluoroelastomer (A)];
0.30 to 2.5 phr based on 100 phr of fluoroelastomer (A) of at least one organic aromatic acid, [acid (OA)], which is a compound comprising at least one aromatic ring and at least one acid group, which is linked to said aromatic ring via a sigma bond or a linking group, with the proviso that when the acid group is —COOH the aromatic ring does not comprise an —OH group in the para- or meta-position with respect to said acid group; and
at least one pyridinium salt [salt (P)] complying with any of formulae (P1) to (P12):

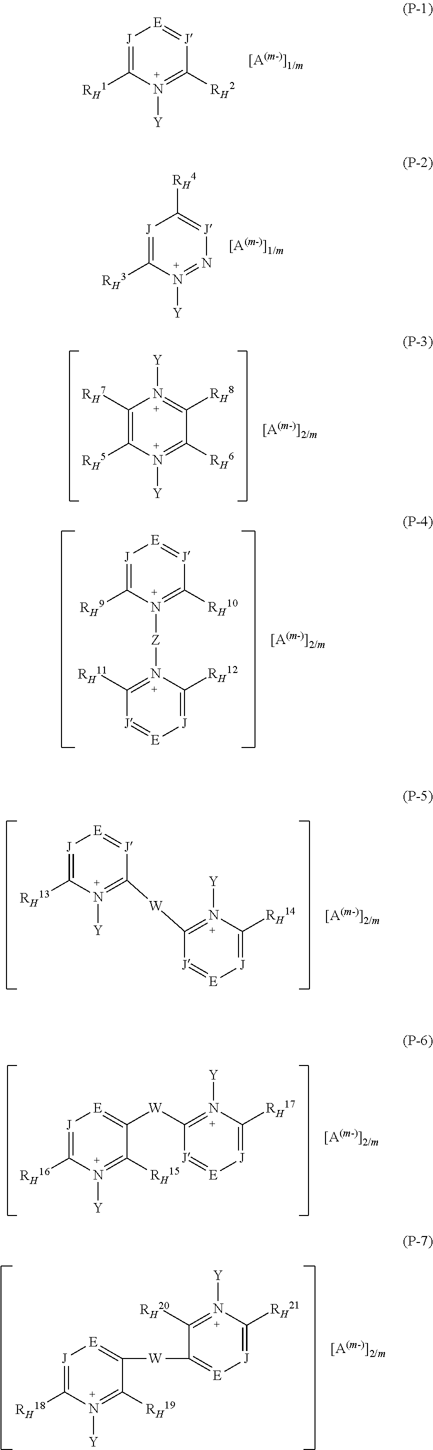

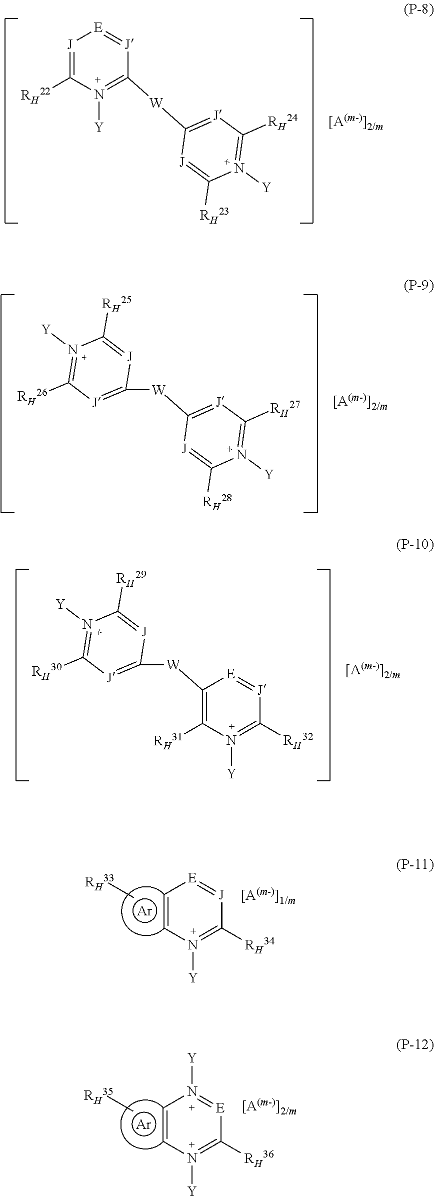

wherein:
each of J and J′, equal to or different from each other, is independently at each occurrence C—R* or N, wherein R* is H or a C₁-C₁₂ hydrocarbon group;
E is N or a group of formula C—R^{o}_{H};
Z is a divalent hydrocarbon group comprising from 1 to 12 carbon atoms
W is a bond or is a bridging group selected from the group consisting of divalent hydrocarbon groups comprising from 1 to 12 carbon atoms (preferably divalent aliphatic groups comprising from 1 to 6 carbon atoms) and divalent fluorocarbon groups comprising from 1 to 12 carbon atoms (preferably divalent perfluoroaliphatic groups comprising from 1 to 6 carbon atoms);
the group sketched with symbol:

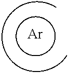

in formula (P-11) and (P-12) designates an aromatic mono- or poly-nuclear ring condensed to the pyridinium-type aromatic ring, which may comprise one or more additional nitrogen atoms, optionally quaternized nitrogen atoms, in the ring(s);
each of R¹_{H}, R²_{H}, R³_{H}, R⁴_{H}, R⁵_{H}, R⁶_{H}, R⁷_{H}, R⁸_{H}, R⁹_{H}, R¹⁰_{H}, R¹¹_{H}, R¹²_{H}, R¹³_{H}, R¹⁴_{H}, R¹⁵_{H}, R¹⁶_{H}, R¹⁷_{H}, R¹⁸_{H}, R¹⁹_{H}, R²⁰_{H}, R²¹_{H}, R²²_{H}, R²³_{H}, R²⁴_{H}, R²⁵_{H}, R²⁶_{H}, R²⁷_{H}, R²⁸_{H}, R²⁹_{H}, R³⁰_{H}, R³¹_{H}, R³²_{H}, R³³_{H}, R³⁴_{H}, R³⁵_{H}, R³⁶_{H} and R^{o}_{H}, equal to or different from each other, is independently at each occurrence —H or a group of formula [group (alpha-H)]:

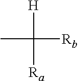

wherein Rₐ, and R_{b}, equal to or different from each other, are independently H or a hydrocarbon C₁-C₆ group;
Y, equal to or different from each other, is independently oxygen or a C₁-C₁₂ hydrocarbon group, which can be notably an aliphatic or an aromatic group, which can comprise one or more than one heteroatoms selected from N, O, S and halogens;
A^{(m-)} is an anion having valency m;
with the proviso that
(i) when salt (P) is of formula (P-1) at least two of R¹_{H}, R²_{H}, and R^{o}_{H} are groups (alpha-H);
(ii) when salt (P) is of formula (P-2) R³_{H} and R⁴_{H} are groups (alpha-H); (iii) when salt (P) is of formula (P-3), at least two of R⁵_{H}, R⁶_{H}, R⁷_{H}, and R⁸_{H} are groups (alpha-H);
(iv) when salt (P) is of formula (P-4), at least two of R⁹_{H}, R¹⁰_{H}, R¹¹_{H}, R¹²_{H}, and R^{o}_{H} are groups (alpha-H);
(v) when salt (P) is of formula (P-5), at least two of R¹³_{H}, R¹⁴_{H}, and R^{o}_{H} are groups (alpha-H);
(vi) when salt (P) is of formula (P-6), at least two of R¹⁵_{H}, R¹⁶_{H}, R¹⁷_{H}, and R^{o}_{H} are groups (alpha-H);
(vii) when salt (P) is of formula (P-7), at least two of R¹⁸_{H}, R¹⁹_{H}, R²⁰_{H}, R²¹_{H}, and R^{o}_{H} are groups (alpha-H);
(viii) when salt (P) is of formula (P-8), at least two of R²²_{H}, R²³_{H}, R²⁴_{H}, and R^{o}_{H} are groups (alpha-H);
(ix) when salt (P) is of formula (P-9), at least two of R²⁵_{H}, R²⁶_{H}, R²⁷_{H}, and R²⁸_{H} are groups (alpha-H);
(x) when salt (P) is of formula (P-10), at least two of R²⁹_{H}, R³⁰_{H}, R³¹_{H}, R³²_{H}, and R²⁸_{H} are groups (alpha-H);
(xi) when salt (P) is of formula (P-11), at least two of R³³_{H}, R³⁴_{H}, and R²⁸_{H} are groups (alpha-H);
(xii) when salt (P) is of formula (P-12), at least two of R³⁵_{H}, R³⁶_{H} and R^{o}_{H} are groups (alpha-H).

In a second embodiment, the present invention relates to a method for fabricating shaped articles, comprising the use of the above mentioned composition (C).

In a third embodiment, the present invention also relates to cured articles obtained from the above mentioned composition (C).

### BRIEF DESCRIPTION OF DRAWINGS

FIG. 1 is a chart representing the cure behaviours of Example 1C(*) of comparison and Examples 4 and 5 according to the invention, characterized by Moving Die Rheometer (MDR), at 170° C.

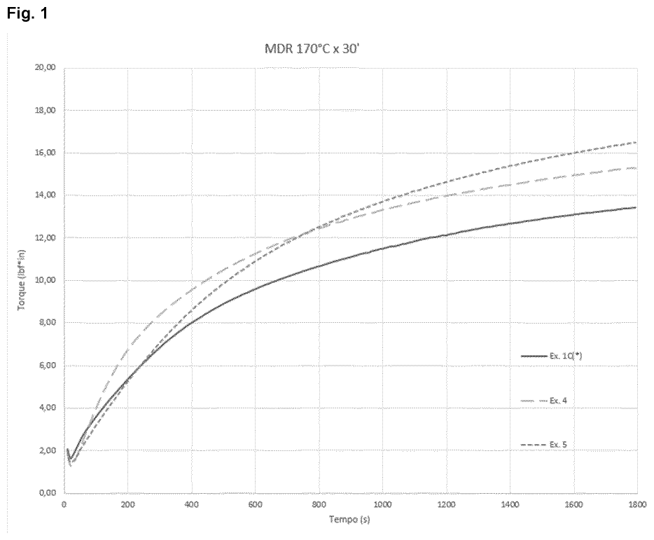

### DESCRIPTION OF EMBODIMENTS

For the purposes of this invention, the term “fluoroelastomer” [fluoroelastomer (A)] is intended to designate a fluoropolymer resin serving as a base constituent for obtaining a true elastomer, said fluoropolymer resin comprising more than 10% wt, preferably more than 30% wt, of recurring units derived from at least one ethylenically unsaturated monomer comprising at least one fluorine atom (hereafter, (per)fluorinated monomer) and, optionally, recurring units derived from at least one ethylenically unsaturated monomer free from fluorine atom (hereafter, hydrogenated monomer).

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

A first object of the invention is a fluoroelastomer composition [composition (C)] comprising:
at least one vinylidene-fluoride based fluoroelastomer comprising recurring units derived from vinylidene fluoride (VDF) and from at least one additional (per)fluorinated monomer different from VDF [fluoroelastomer (A)];
0.30 to 2.50 phr based on 100 phr of fluoroelastomer (A) of at least one organic aromatic acid [acid (OA)] which is a compound comprising at least one aromatic ring and at least one acid group, which is linked to said aromatic ring via a sigma bond or a linking group, with the proviso that when the acid group is —COOH the aromatic ring does not comprise an —OH group in the para- or meta-position with respect to said acid group; and
at least one pyridinium salt [salt (P)] complying with any of formulae (P1) to (P12) as detailed above.

The composition may be free of any polyhydroxyaromatic compound crosslinking agent. The composition may typically be free of bisphenol crosslinking agents.

Fluoroelastomers (A) are in general amorphous products or products having a low degree of crystallinity (crystalline phase less than 20% by volume) and a glass transition temperature (T_{g}) below room temperature. In most cases, the fluoroelastomer (A) has advantageously a T_{g} below 10° C., preferably below 5° C., more preferably 0° C., even more preferably below −5° C.

Fluoroelastomer (A) typically comprises at least 15 mol %, preferably at least 20 mol %, more preferably at least 35 mol % of recurring units derived from VDF, with respect to all recurring units of the fluoroelastomer.

Fluoroelastomer (A) typically comprises at most 85 mol %, preferably at most 80 mol %, more preferably at most 78 mol % of recurring units derived from VDF, with respect to all recurring units of the fluoroelastomer.

Non limitative examples of suitable (per)fluorinated monomers different from VDF are notably:
(a) C₂-C₈ perfluoroolefins, such as tetrafluoroethylene (TFE) and hexafluoropropylene (HFP);
(b) hydrogen-containing C₂—C olefins different from VDF, such as vinyl fluoride (VF), trifluoroethylene (TrFE), perfluoroalkyl ethylenes of formula CH₂=CH—R_{f}, wherein R_{f} is a C₁-C₆ perfluoroalkyl group;
(c) C₂-C₈ chloro and/or bromo and/or iodo-fluoroolefins such as chlorotrifluoroethylene (CTFE);
(d) (per)fluoroalkylvinylethers (PAVE) of formula CF₂=CFOR_{f}, wherein R_{f} is a C₁-C₆ (per)fluoroalkyl group, e.g. CF₃, C₂F₅, C₃F₇;
(e) (per)fluoro-oxy-alkylvinylethers of formula CF₂=CFOX, wherein X is a C₁-C₁₂ ((per)fluoro)-oxyalkyl comprising catenary oxygen atoms, e.g. the perfluoro-2-propoxypropyl group;
(f) (per)fluorodioxoles having formula:

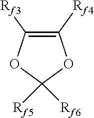

wherein each of R_{f3}, R_{f4}, R_{f5}, R_{f6}, equal or different each other, is independently a fluorine atom, a C₁-C₆ fluoro- or per(halo)fluoroalkyl, optionally comprising one or more oxygen atom, e.g. —CF₃, —C₂F₅, —C₃F₇, —OCF₃, —OCF₂CF₂OCF₃.
(g) (per)fluoro-methoxy-vinylethers (MOVE, hereinafter) having formula:

CFX₂═CX₂OCF₂OR″_{f}
wherein R″_{f} is selected among C₁-C₆ (per)fluoroalkyls, linear or branched; C₅-C₆ cyclic (per)fluoroalkyls; and C₂—C(per)fluorooxyalkyls, linear or branched, comprising from 1 to 3 catenary oxygen atoms, and X₂=F, H; preferably X₂ is F and R″_{f} is —CF₂CF₃ (MOVE1); —CF₂CF₂OCF₃ (MOVE2); or —CF₃ (MOVE3).

Generally fluoroelastomer (A) will comprise recurring units derived from VDF and recurring units derived from HFP.

Fluoroelastomer (A) may optionally further comprise recurring units derived from one or more than one monomer free from fluorine (hydrogenated monomer, hereinafter). Examples of hydrogenated monomers are notably C₂-C₈ non-fluorinated olefins (O), in particular C₂—C non-fluorinated alpha-olefins (O), including ethylene, propylene, 1-butene; diene monomers; styrene monomers; C₂—C non-fluorinated alpha-olefins (OI), and more particularly ethylene and propylene, will be selected for achieving increased resistance to bases.

Optionally, fluoroelastomer (A) may comprises recurring units derived from at least one bis-olefin [bis-olefin (OF)] having general formula

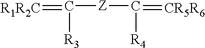

wherein R₁, R₂, R₃, R₄, R₅ and R₆, equal or different from each other, are H, a halogen, or a C₁-C₅ optionally halogenated group, possibly comprising one or more oxygen group; Z is a linear or branched C₁-C₁₈ optionally halogenated alkylene or cycloalkylene radical, optionally containing oxygen atoms, or a (per)fluoropolyoxyalkylene radical, e.g. as described in EP 661304 A (AUSIMONT SPA) 5/07/1995.

The bis-olefin (OF) is preferably selected from the group consisting of those complying with formulae (OF-1), (OF-2) and (OF-3):

### (OF-1)

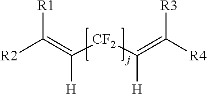

wherein j is an integer between 2 and 10, preferably between 4 and 8, and R1, R2, R3, R4, equal or different from each other, are H, F or C₁₋₅ alkyl or (per)fluoroalkyl group;

### (OF-2)

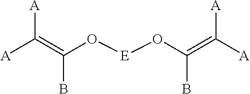

wherein each of A, equal or different from each other and at each occurrence, is independently selected from F, Cl, and H; each of B, equal or different from each other and at each occurrence, is independently selected from F, Cl, H and OR_{B}, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ— group, with m being an integer from 3 to 5; a preferred bis-olefin of (OF-2) type is F₂C═CF—O—(CF₂)₅—O—CF═CF₂.

### (OF-3)

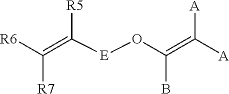

wherein E, A and B have the same meaning as above defined; R5, R6, R7, equal or different from each other, are H, F or C-s alkyl or (per)fluoroalkyl group.

Fluoroelastomers (A) suitable in the compositions of the invention may comprise, in addition to recurring units derived from VDF and HFP, one or more of the followings:
recurring units derived from at least one bis-olefin [bis-olefin (OF)] as above detailed;
recurring units derived from at least one (per)fluorinated monomer different from VDF and HFP; and
recurring units derived from at least one hydrogenated monomer.

Among specific monomer compositions of fluoroelastomers (A) suitable for the purpose of the invention, mention can be made of fluoroelastomers having the following monomer compositions (in mol %):
(i) vinylidene fluoride (VDF) 35-85%, hexafluoropropene (HFP) 10-45%, tetrafluoroethylene (TFE) 0-30%, perfluoroalkyl vinyl ethers (PAVE) 0-15%, bis-olefin (OF) 0-5%;
(ii) vinylidene fluoride (VDF) 50-80%, perfluoroalkyl vinyl ethers (PAVE) 5-50%, tetrafluoroethylene (TFE) 0-20%, bis-olefin (OF) 0-5%;
(iii) vinylidene fluoride (VDF) 20-30%, C₂-C₈ non-fluorinated olefins (OI) 10-30%, hexafluoropropene (HFP) and/or perfluoroalkyl vinyl ethers (PAVE) 18-27%, tetrafluoroethylene (TFE) 10-30%, bis-olefin (OF) 0-5%;
(iv) tetrafluoroethylene (TFE) 45-65%, C₂—C non-fluorinated olefins (01) 20-55%, vinylidene fluoride (VDF) 0.1-30%, bis-olefin (OF) 0-5%,
(v) tetrafluoroethylene (TFE) 33-75%, perfluoroalkyl vinyl ethers (PAVE) 15-45%, vinylidene fluoride (VDF) 5-30%, hexafluoropropene HFP 0-30%, bis-olefin (OF) 0-5%;
(vi) vinylidene fluoride (VDF) 35-85%, fluorovinyl ethers (MOVE) 5-40%, perfluoroalkyl vinyl ethers (PAVE) 0-30%, tetrafluoroethylene (TFE) 0-40%, hexafluoropropene (HFP) 0-30%, bis-olefin (OF) 0-5%.

Organic aromatic acid [acid (OA)] is a compound comprising at least one aromatic ring and at least one acid group, which is linked to said aromatic ring via a sigma bond or a linking group, with the proviso that when the acid group is —COOH the aromatic ring does not comprise an —OH group in the para- or meta-position with respect to said acid group.

Preferably, said acid group is linked to said aromatic ring via a sigma bond.

Preferably, said acid group is selected from —COOH or —SO₃H. More preferably, said acid group is —SO₃H.

Hence, in certain embodiments the invention is a fluoroelastomer composition comprising:
at least one fluoroelastomer (A);
0.30 to 2.50 phr based on 100 phr of fluoroelastomer (A) of at least one organic aromatic acid [acid (OA)] which is a compound comprising at least one aromatic ring and at least one acid —SO₃H group, which is linked to said aromatic ring via a sigma bond or a linking group; and
at least one salt (P) as detailed above.

Preferably, organic aromatic acid [acid (OA)] comprises one electron donating group (also referred to as electron releasing group) in the para-position with respect to said acid group.

More preferably, said electron donating group is selected from C1-C5 alkyl, such as —CH₃, —CH₂CH₃, and —OH, most preferably the electron donating group is selected from C1-C5 alkyls, preferably —CH₃ and —CH₂CH₃

Even more preferably, said acid (OA) is selected from p-toluenesulfonic acid.

Advantageously, composition (C) comprises acid (OA) in an amount from 0.30 to 2.20 weight parts (phr) per 100 weight parts (phr) of fluoroelastomer (A), even from 0.30 to 2.10 phr per 100 phr of fluoroelastomer (A) or even 0.30 to 2.00 phr per 100 phr of fluoroelastomer (A).

Good results have been obtained with p-toluenesulfonic acid in an amount from 0.30 to 1.00 phr, preferably from 0.30 to 0.80 phr per 100 phr of fluoroelastomer (A).

Preferred salts (P) of formula (P-1) are those complying with formulae (P-1-a) to (P-1-e):

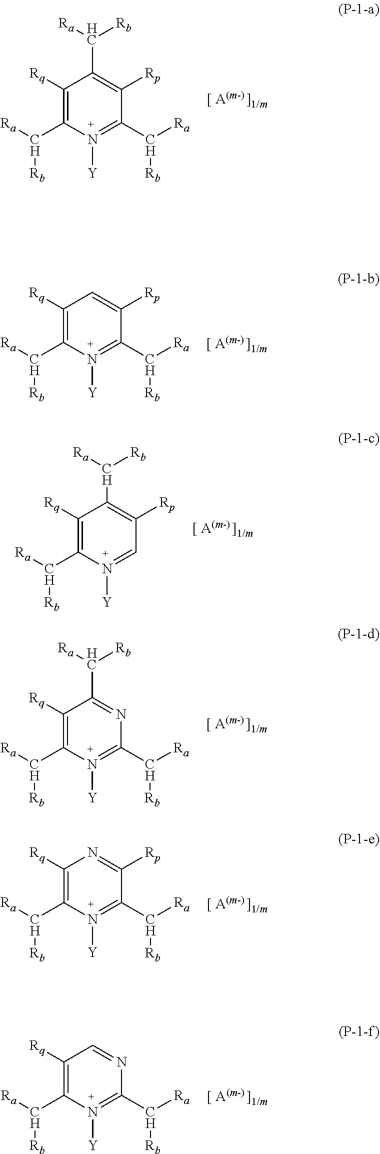

wherein:
Rₐ and R_{b} have the meaning as above defined, preferably Rₐ and R_{b} are H;
Y has the meaning as defined above, preferably Y is methyl;
each of Rₚ and R_{q}, equal to or different from each other, is H or a C₁-C₁₂ hydrocarbon group;
A and m have the meanings as defined above.

More preferably, salts (P) of formula (P-1) are those having any of formulae (P-1-g) to (P-1-p):

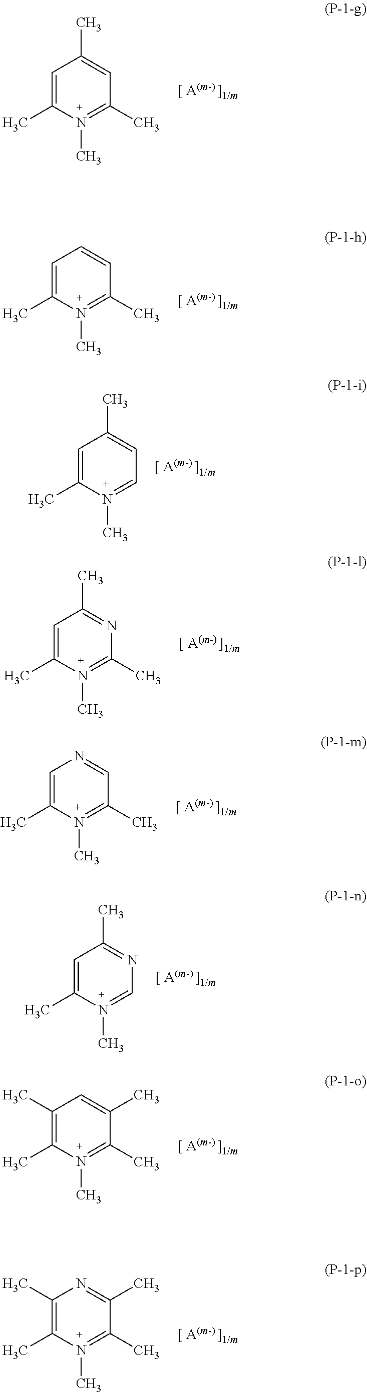

wherein A and m have the meaning as defined above.

Preferred salts (P) of formula (P-2) are those complying with formula (P-2-a):

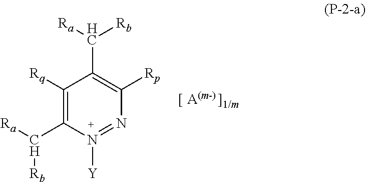

wherein:
Rₐ and R_{b} have the meaning as above defined, preferably Rₐ and R_{b} are H;
Y has the meaning as defined above, preferably Y is methyl;
each of Rₚ and R_{q}, equal to or different from each other, is H or a C₁-C₁₂ hydrocarbon group;
A and m have the meanings as defined above.

More preferably, salts (P) of formula (P-2) are those having formula (P-2-b)

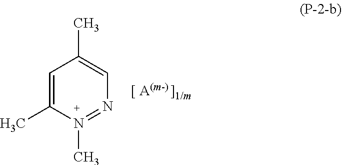

wherein A and m have the meaning as defined above.

Preferred salts (P) of formula (P-3) are those complying with formula (P-3-a):

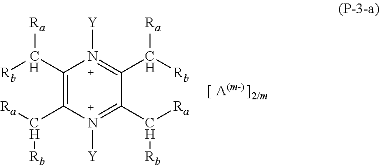

wherein:
Rₐ and R_{b} have the meaning as above defined, preferably Rₐ and R_{b} are H;
Y has the meaning as defined above, preferably Y is methyl;
A and m have the meanings as defined above.

More preferably, salts (P) of formula (P-3) are those having formula (P-3-b)

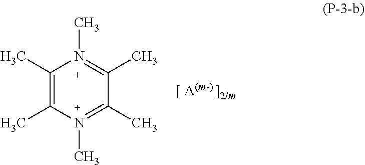

wherein A and m have the meaning as defined above.

Preferred salts (P) of formula (P-4) are those complying with formula (P-4-a):

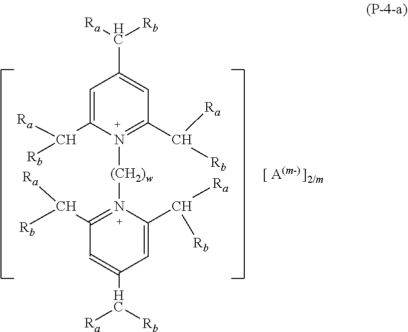

wherein:
Rₐ and R_{b} have the meaning as above defined, preferably Rₐ and R_{b} are H;
w is an integer of 1 to 12, preferably of 1 to 6, most preferably equal to 3;
A and m have the meanings as defined above.

More preferably, salts (P) of formula (P-4) are those having formula (P-4-b) or (P-4-c):

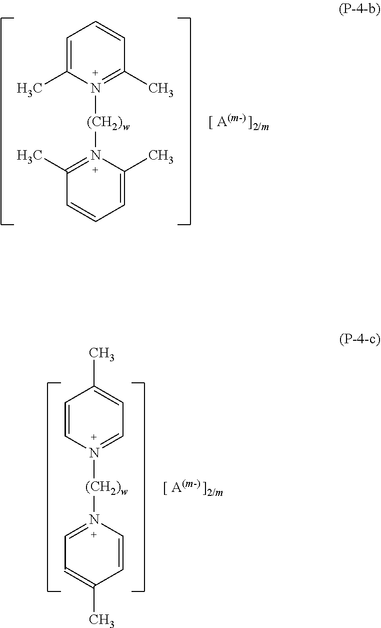

wherein A, and m have the meaning as defined above, and w=3.

Preferred salts (P) of formula (P-5) are those complying with formula (P-5-a):

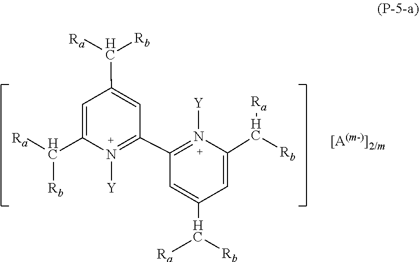

wherein:
Rₐ and R_{b} have the meaning as above defined, preferably Rₐ and R_{b} are H;
Y has the meaning as defined above, preferably Y is methyl;
A and m have the meanings as defined above.

More preferably, salts (P) of formula (P-5) are those having formula (P-5-b) or (P-5-c):

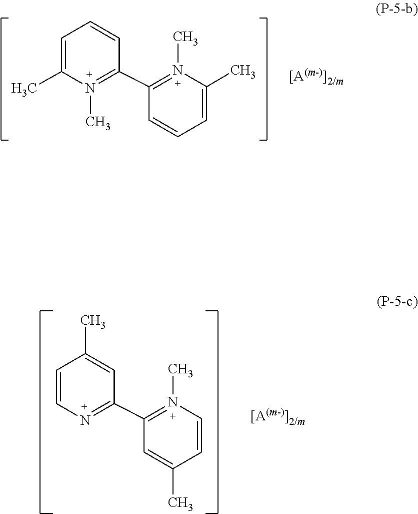

wherein A and m have the meaning as defined above.

Preferred salts (P) of formula (P-11) are those complying with formula (P-11-a):

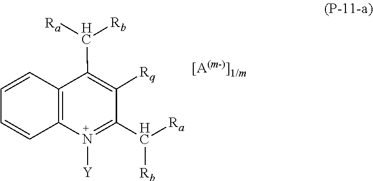

wherein:
Rₐ and R_{b} have the meaning as above defined, preferably Rₐ and R_{b} are H;
Y has the meaning as defined above, preferably Y is methyl;
A and m have the meanings as defined above.

More preferably, salts (P) of formula (P-11) are those having formula (P-11-b):

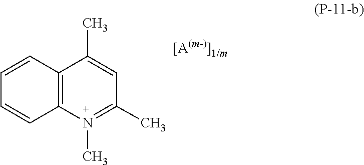

wherein A and m have the meaning as defined above.

Preferred salts (P) of formula (P-12) are those complying with formula (P-12-a):

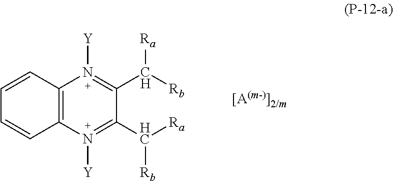

wherein:
Rₐ and R_{b} have the meaning as above defined, preferably Rₐ and R_{b} are H;
Y has the meaning as defined above, preferably Y is methyl;
A and m have the meanings as defined above.

More preferably, salts (P) of formula (P-12) are those having formula (P-12-b):

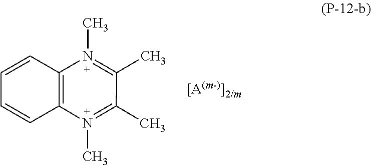

wherein A and m have the meaning as defined above.

The choice of the anion A in formulae (P-1) to (P-12) is not particularly critical; it is nevertheless understood that anions selected from the group consisting of arylsulfonates, in particular, tosylate (p-toluensulfonate), (fluoro)alkyl sulfonates having a C₁-C₆ (fluoro)alkyl chain, including fluorine-free alkyl sulfonates e.g. mesylate (methansulfonate) and fluorine containing (especially perfluorinated) alkyl sulfonates, e.g. triflate (trifluoromethansulfonate); halides (iodide, bromide, chloride) are particularly preferred because of their prompt accessibility from synthetic perspective.

As a whole, exemplary compounds which have been found particular utility in the composition of the present invention are those listed below having formulae (Ex-1) to (Ex-9):

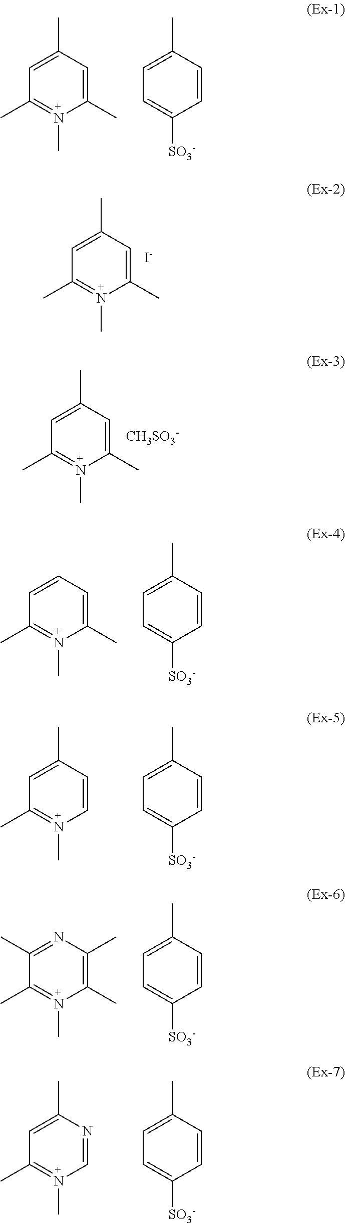

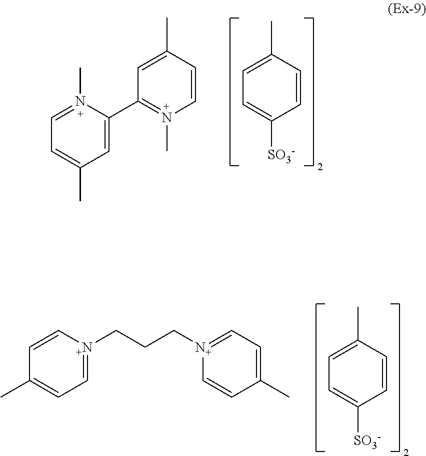

The composition of the invention generally comprises salt (P) in an amount of at least 0.1, preferably at least 0.5, more preferably at least 1 phr per 100 phr of fluoroelastomer (A).

The composition of the invention generally comprises salt (P) in an amount of at most 20, preferably at most 15, more preferably at most 10 phr per 100 phr of fluoroelastomer (A).

Optionally, composition (C) of the invention comprises at least one basic compound [base (B)]

The base (B) suitable for being used in the composition (C) of the present invention is not particularly limited.

Base (B) can be selected from organic bases, inorganic bases or mixtures of at least one organic and at least one inorganic bases.

Among inorganic bases [bases (IB)] mention can be notably made of:
(i) divalent metal oxides, in particular oxides of alkali-earth metals or oxides of Zn, Mg, Pb, Ca, including specifically MgO, PbO and ZnO;
(ii) hydroxides of metals, in particular hydroxides of monovalent and divalent metals, specifically hydroxides of alkali and alkali-earth metals, in particular hydroxides selected from the group consisting of Ca(OH)₂, Sr(OH)₂, and Ba(OH)₂; (iii) metal salts of weak acids having a pKₐ higher than 3, in particular weak acids selected from the group consisting of carbonates, benzoates, oxalates and phosphites; in particular carbonates, benzoates, oxalates and phosphites salts with Na, K, Ca, Sr, Ba.

Among inorganic bases, Ca(OH)₂ has been found to be particularly effective.

Among organic based [bases (OB)] mention can be notably made of:
(j) non-aromatic amines or amides complying with general formula (B1m) or (B1d):

R_{b}—[C(O)]ₜNR^{H}₂ (B1m)

R^{H}₂N—[C(O)]ₜ—R_{dm}—[C(O)]ₜ—NR^{H}₂ (B1d)
wherein:
   each of t, t′ and t″, equal to or different from each other and at each occurrence is zero or 1;
   each of R^{H} is independently H or a C₁-C₁₂ hydrocarbon group;
   R_{bm} is a monovalent hydrocarbon non-aromatic group having 1 to 30 carbon atoms;
   R_{bm} is a divalent hydrocarbon non-aromatic group having 1 to 30 carbon atoms; and
(jj) cycloaliphatic secondary or tertiary amines complying with general formula (B2m) or (B2d):

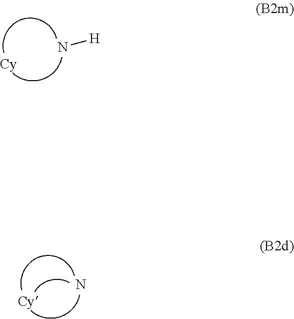

wherein:
   Cy represents a divalent aliphatic group comprising at least 4 carbon atoms, optionally comprising one or more than one ethylenically unsaturated double bond, and optionally comprising one or more catenary nitrogen atoms, forming a cycle with the nitrogen atom which is connected thereto;
   Cy′ represent a trivalent aliphatic group comprising at least 5 carbon atoms, optionally comprising one or more than one ethylenically unsaturated double bond, and optionally comprising one or more catenary nitrogen atoms, forming a cycle with the nitrogen atom which is connected thereto;
(jjj) aromatic amines or amides complying with general formula (B3):

Ar_{b}—{[C(O)]ₜ—NR^{H}₂}_{w} (B3)
wherein:
   t, equal to or different from each other and at each occurrence, is zero or 1;
   w is an integer of 1 to 4;
   each of R^{H} is independently H or a C₁-C₁₂ hydrocarbon group;
   Ar_{b} is a mono- or poly-nuclear aromatic group, possibly comprising one or more than one catenary heteroatoms selected from the group consisting of S and O;
(jv) heteroaromatic amines comprising at least one nitrogen atom comprised in a heteroaromatic cycle, in particular pyridine derivatives, preferably trimethylpyridine isomers;
(v) guanidine derivatives of formula (B4) or (B5):

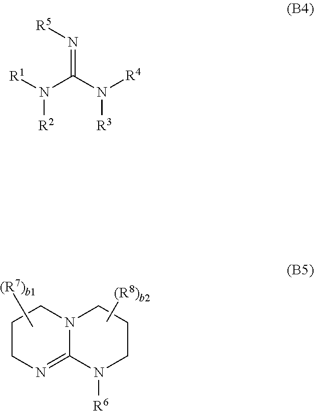

wherein:
   each of R¹, R², R³, R⁴, R⁵, R⁶, R⁷, and R⁸, equal to or different from each other, is independently H or a C₁-C₁₂ hydrocarbon group
and corresponding salts of said guanidines (B4) and (B5), in particular corresponding N-quaternized hydrohalides (preferably hydrochlorides);
(vj) metal alkoxylates, preferably alkoxylates of aliphatic alcohols, more preferably potassium terbutylate, sodium ethylate and sodium methylate.

Among bases of formulae (B1m) and (B1d), those wherein:
R_{bm} is a monovalent aliphatic linear group having 6 to 30 carbon atoms, possibly comprising one or more than one ethylenically unsaturated double bond; and
R_{dm} is a divalent aliphatic linear group having 6 to 30 carbon atoms, possibly comprising one or more than one ethylenically unsaturated double bond, are particularly preferred.

Among said non-aromatic amines or amides complying with general formula (B3), mention can be particularly made of:
octadecylamine of formula CH₃(CH₂)₁₇—NH₂;
erucamide of formula H₂N—C(O)—(CH₂)₁₁—CH═CH—(CH₂)₇CH₃;
oleamide of formula H₂N—C(O)—(CH₂)₇—CH═CH—(CH₂)₇CH₃;
hexamethylenediamine of formula H₂N—(CH₂)₆—NH₂;
N,N-dimethyloctylamine;
N,N-dimethyldodecylamine;
trioctylamine;
trihexylamine.

Among the said cycloaliphatic secondary or tertiary amines complying with general formula (B2m) or (B2d), mention can be made of 1,8-diazabicycloundec-7-ene (DBU) of formula:

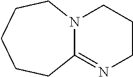

Exemplary embodiments of said guanidine derivatives of formula (B-4) are notably guanidine hydrochloride and di-o-tolylguanidine.

The amount of base (B) will be adjusted by one of ordinary skills in the art, taking into account the nature and basicity of base (B) used.

It is nevertheless understood that the composition (C) generally comprises from 0.2 to 20, preferably from 6 to 16 weight parts of said base (B) (organic and/or inorganic, as above detailed) per 100 weight parts of fluoroelastomer (A).

According to certain preferred embodiments, composition (C) comprises at least one organic base and at least one inorganic base.

In these circumstances, composition (C) generally comprises from 0.1 to 10, preferably from 6 to 16 weight parts of said inorganic base and/or generally, from 0.1 to 10, preferably from 6 to 16 weight parts of said organic base, these weight parts being referred to 100 weight parts of fluoroelastomer (A).

The composition (C) may additionally comprise one or more than one organic solvents [solvent (S)].

Said organic solvent is preferably selected from those wherein the used salt (P) has a solubility at room temperature exceeding 1 g/l, more preferably 10 g/l.

Non-limitative examples of solvents (S) which can be used are notably:
polar aprotic organic solvents, selected preferably from the group consisting of sulfolane, 4,4′-dichlorodiphenylsulfone;
ionic liquids, selected preferably from the group consisting of methylpyrrolidinium bis(trifluoromethansulonylimide) of formula PY1,4-Tf₂N and 1-butyl-3-methylimidazolium bis(trifluoromethylsulfonylimide) of formula BMIm-Tf₂N:

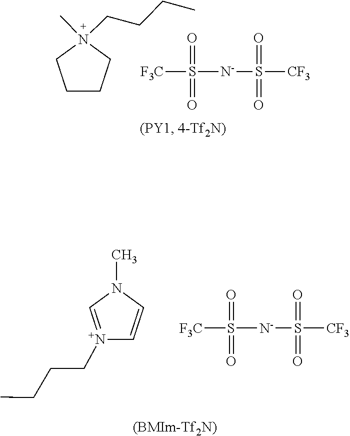

Also, other conventional additives, such as reinforcing fillers (e.g. carbon black), thickeners, pigments, antioxidants, stabilizers and the like, may then be added to the composition (C).

The invention also pertains to a method of using the composition (C), as above described, for fabricating shaped articles.

The composition (C) can be fabricated, e.g. by moulding (injection moulding, extrusion moulding), calendering, or extrusion, into the desired shaped article, which is advantageously subjected to vulcanization (curing) during the processing itself and/or in a subsequent step (post-treatment or post-cure), advantageously transforming the relatively soft, weak, fluoroelastomer (A) into a finished article made of non-tacky, strong, insoluble, chemically and thermally resistant cured fluoroelastomer.

Finally, the invention pertains to cured articles obtained from the composition (C), as detailed above.

The cured articles can be notably pipes, joints, O-ring, hose, and the like.

The invention will be now described with reference to the following examples, whose purpose is merely illustrative and not intended to limit the scope of the invention.

### Experimental Section

### Materials

VDF-HFP copolymer commercially available under trade name TECNOFLON® 90HS from Solvay Specialty Polymers Italy S.p.A. (FKM-1, hereinafter) was used as base fluoroelastomer.

MAGLITE® DE high surface area, high activity magnesium oxide (MgO, hereinafter) was obtained from Merck.

RHENOFIT® CF (GE 1890) calcium hydroxide (Ca(OH)₂, hereinafter) was obtained from Rhein Chemie.

Reinforcing filler Carbon black N990MT was obtained from Cancarb (NT990, hereinafter).

Guanidine, p-toluensulfonic acid and 4-hydroxybenzoic acid were obtained by Merck Sigma Aldrich

### Methods

### Characterization of Cure Behaviour

The cure behaviour was characterized by Moving Die Rheometer (MDR), at 170° C. and at 180° C., by determining the following properties:
M_{L}=Minimum torque (lb×in)
M_{H}=Maximum torque (lb×in)
ΔM=M_{H}−M_{L} (lb×in)
ts2=time for the viscosity to increase of 2 units above M_{L}

Plaques and O-rings (size class=214) have been cured in a pressed mould and then post-treated in an air circulating oven under the following conditions:
moulding=90 minutes @170° C.
postcure=(8+16 hours) @230° C.

The Mooney scorch time was determined at 135° C. according to ASTM D1646 using Alpha Technologies Mooney MV200.

### Mechanical Properties

The tensile properties were determined on specimens punched out from the plaques, according to the ASTMD412C Standard at 23° C.
T.S.=tensile strength in MPa
M 50=tensile strength in MPa at an elongation of 50%
M 100=tensile strength in MPa at an elongation of 100%
E.B.=elongation at break in %.

Shore A hardness (3″) (HDS) was determined on 3 pieces of plaque piled according to the ASTM D 2240 method.

The compression set (C-SET) was determined on O-ring, specimen standard AS568A (type 214) or on 6 mm buttons (type 2), according to the ASTM D 395, method B, at 200° C. for 70 h.

### Preparative Example A—1,2,4,6-tetramethyl-pyridinium p-toluenesulphonate [same as Preparative Example 1 in WO 2016/180660]

A three-necked round bottom flask equipped with a thermometer, condenser and stirring was charged with CH₂Cl₂ (85 ml) and methyl-p-toluenesulphonate (25.50 g). Then 2,4,6 trimethylpyridine (16.59 g) was added dropwise at room temperature. The reaction was stirred at 50° C. and, after 22 hours, it was completed. The liquid phase was removed by evaporation under vacuum obtaining a white powder that was dispersed in diethyl-ether (50 ml) under stirring. The liquid phase was filtered off and 39.13 g of pure product was recovered as a white powder in 93% yield (melting point 161° C.; 1% weight loss: 266° C.).

¹H NMR (solvent D₂O, TMS reference): +7.70 ppm (d; 2H; ortho-H; p-toluenesulfonate); +7.55 (s; 2H; meta-H; 1,2,4,6-tetramethyl-pyridinium); +7.39 (d; ²H; meta-H; p-toluenesulfonate); +4.0 (s; 3H; NCH₃; 1,2,4,6-tetramethyl-pyridinium); +2.74 (s; 6H; ortho-CH3; 1,2,4,6-tetramethyl-pyridinium); 2.53 (s; 3H; para-CH₃; 1,2,4,6-tetramethyl-pyridinium); +2.44 ppm (s; 3H; para-CH₃; p-toluenesulfonate).

### Preparative Example B—Compounding Procedure

The salt (P) of preparative example A above was compounded between rolls to prepare curable compounds in combination with the other ingredients in the amounts (in phr) listed in the following Table 1.

TABLE 1

| | Ex. 1C | Ex. 2C | Ex. 3C | Ex. 4C | | | | | Ex. 5C | Ex. 6C |
|---|---|---|---|---|---|---|---|---|---|---|
| Ingredient | (*) | (*) | (*) | (*) | Ex. 1 | Ex. 2 | Ex. 3 | Ex. 4 | (*) | (*) |
| Elastomer | 100.0 | 100.0 | 100.0 | 100.0 | 100.0 | 100.0 | 100.0 | 100.0 | 100.0 | 100.0 |
| p-toluene | — | — | 0.10 | 0.20 | 0.30 | 0.50 | 0.60 | 0.75 | — | — |
| sulfonic | | | | | | | | | | |
| acid | | | | | | | | | | |
| 4-hydroxy | — | — | — | — | — | — | — | — | 1.03 | 2.06 |
| benzoic | | | | | | | | | | |
| acid | | | | | | | | | | |
| Pyridinium | 1.83 | 1.83 | 1.83 | 1.83 | 1.83 | 1.83 | 1.83 | 1.83 | 1.83 | 1.83 |
| salt | | | | | | | | | | |
| N990 MT | 30.00 | 30.00 | 30.00 | 30.00 | 30.00 | 30.00 | 30.00 | 30.00 | 30.00 | 30.00 |
| Maglite DE | 3.00 | — | 3.00 | 3.00 | 3.00 | 3.00 | 3.00 | 3.00 | 3.00 | 3.00 |
| Rhenofit CF | 6.00 | 4.00 | 6.00 | 6.00 | 6.00 | 6.00 | 6.00 | 6.00 | 6.00 | 6.00 |
| Guanidine | — | 0.50 | — | — | — | — | — | — | — | — |

(*) comparison

The results of mechanical properties, the viscosity and scorch of the above compositions are summarized in the following Table 2.

TABLE 2

| | Ex.1C | Ex. 2C | | Ex. 4C | | | | | Ex. 5C | Ex. 6C |
|---|---|---|---|---|---|---|---|---|---|---|
| | (*) | (*) | Ex. 3C | (*) | Ex. 1 | Ex. 2 | Ex. 3 | Ex. 4 | (*) | (*) |
| Mooney | 109.0 | — | 97.0 | 87.0 | 82.0 | 77.0 | 79.0 | — | 85.0 | 83.5 |
| viscosity | | | | | | | | | | |
| (MU) | | | | | | | | | | |
| | Curing rate 30 min @170° C. | | | | | | | | | |
| ML (b*in) | 1.6 | 1.4 | 1.3 | 1.1 | 1.1 | 1.0 | 1.1 | — | 1.4 | 1.6 |
| MH (b*in) | 14.1 | 13.5 | 14.3 | 14.5 | 14.2 | 13.2 | 13.8 | — | 16.5 | 16.2 |
| ts2 (s) | 95.0 | 43.0 | 96.0 | 100.0 | 117.0 | 145.0 | 135.0 | — | 113.0 | 162.0 |
| | Mooney Scorch @135° C. | | | | | | | | | |
| MS scorch | 7.35 | — | — | — | — | — | 12.35 | — | 12.70 | 31.00 |
| (min) | | | | | | | | | | |
| | Mechanical properties @23° C. | | | | | | | | | |
| T.S. (MPa) | 15.5 | 13.9 | — | — | — | — | 14.6 | 14.8 | 13.4 | — |
| M50 (MPa) | 2.7 | 3.0 | — | — | — | — | 3.2 | 3.1 | 3.4 | — |
| M100(MPa | 6.0 | 7.2 | — | — | — | — | 7.4 | 7.5 | 6.6 | — |
| E.B.(%) | 216 | 168 | — | — | — | — | 167 | 164 | 200 | — |
| Hardness | 73 | 73 | — | — | — | — | 76 | 76 | 76 | — |
| (shore A) | | | | | | | | | | |
| C-SET (%) | 47.6 | 35 | — | — | — | — | 27.4 | 30.1 | 46.0 | — |

(*) comparison

The data in Table 2 (Ex. 3 vs Ex. 5C) show that higher amounts of p-hydroxybenzoic acid are needed to increase the scorch time but the C-SET of the resulting compositions is negatively impacted.

For further comparison, two compositions were prepared comprising the salt (P) of preparative example A above with an aliphatic acid.

The ingredients were compounded between rolls to prepare curable compounds in combination with the other ingredients in the amounts (in phr) listed in the following Table 3.

TABLE 3

| Ingredient | Ex. 7C (*) | Ex. 8C (*) |
|---|---|---|
| Elastomer | 100.00 | 100.00 |
| | 0.5 | 1.00 |
| Pyridinium salt | 1.83 | 1.83 |
| N990 MT | 30.00 | 30.00 |
| Maglite DE | 3.00 | 3.00 |
| Rhenofit CF | 6.00 | 6.00 |

Properties

| | | |
|---|---|---|
| Mooney viscosity | 86.0 | 83.0 |
| (MU) | | |

Curing rate 30 min @170° C.

| | | |
|---|---|---|
| ML (b*in) | 1.2 | 1.1 |
| MH (b*in) | 19.2 | 22.7 |
| ts2 (s) | 92.0 | 91.0 |

Mooney Scorch @135° C.

| | | |
|---|---|---|
| MS scorch time | 8.60 | 9.45 |
| (min) | | |

(*) comparison

The results in Table 3 showed that the use of stearic acid did not positively affect the MS scorch time of the compositions.

1. A fluoroelastomer composition [composition (C)] comprising:
at least one vinylidene-fluoride based fluoroelastomer comprising recurring units derived from vinylidene fluoride (VDF) and from at least one additional (per)fluorinated monomer different from VDF [fluoroelastomer (A)];
0.30 to 2.50 phr based on 100 phr of fluoroelastomer (A) of at least one organic aromatic acid [acid (OA)] which is a compound comprising at least one aromatic ring and at least one acid group, which is linked to said aromatic ring via a sigma bond or a linking group, with the proviso that when the acid group is —COOH the aromatic ring does not comprise an —OH group in the para- or meta-position with respect to said acid group; and
at least one pyridinium salt [salt (P)] complying with any of formulae (P1) to (P-12): 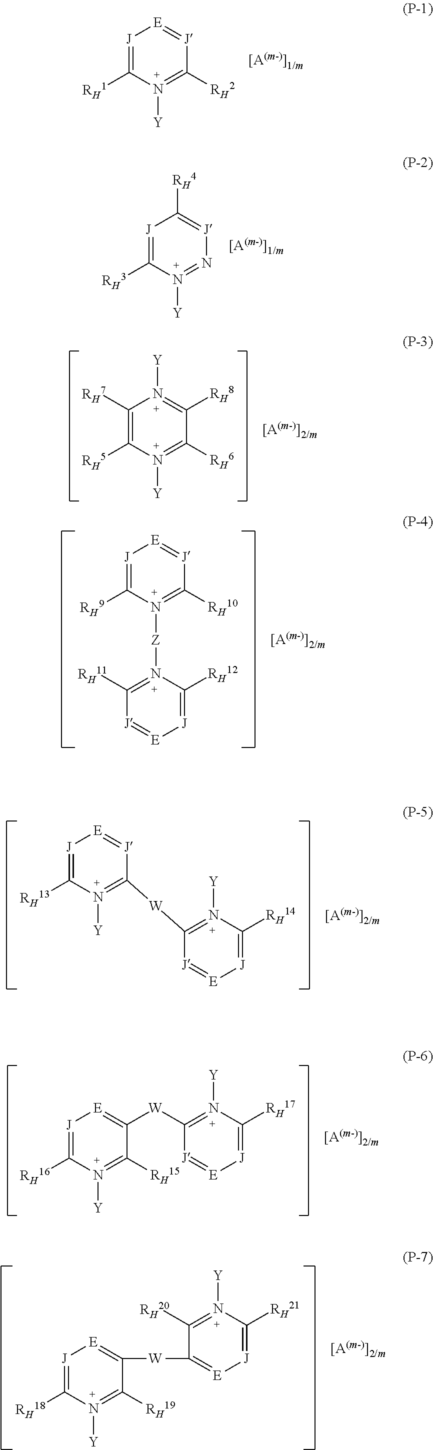 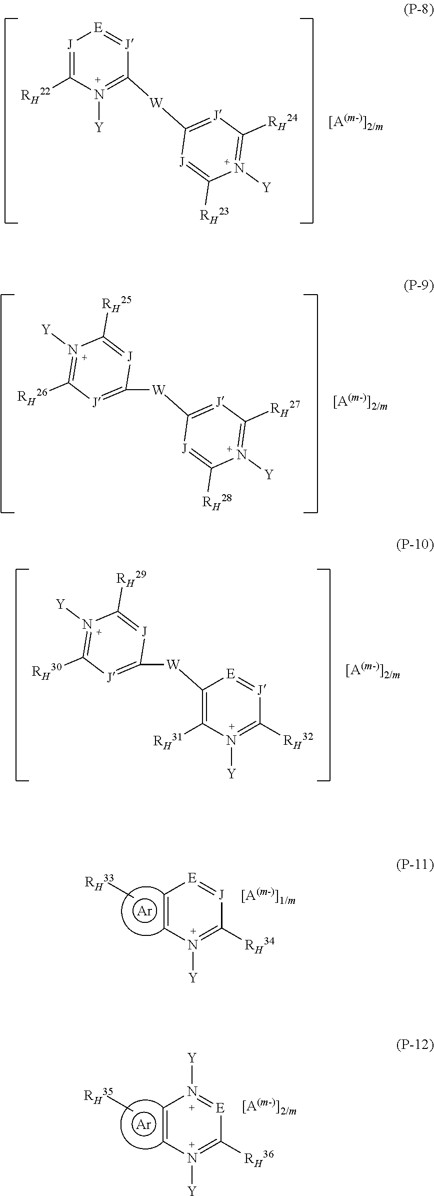
wherein:
each of J and J′, equal to or different from each other, is independently at each occurrence C—R* or N, wherein R* is H or a C₁-C₁₂ hydrocarbon group;
E is N or a group of formula C—R^{o}H;
Z is a divalent hydrocarbon group comprising from 1 to 12 carbon atoms;
W is a bond or is a bridging group selected from the group consisting of divalent hydrocarbon groups comprising from 1 to 12 carbon atoms and divalent fluorocarbon groups comprising from 1 to 12 carbon atoms;
the group sketched with symbol: 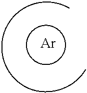
in formula (P-11) and (P-12) designates an aromatic mono- or poly-nuclear ring condensed to the pyridinium-type aromatic ring, which may comprise one or more additional nitrogen atoms, optionally quaternized nitrogen atoms, in the ring(s);
each of R¹_{H}, R²_{H}, R³_{H}, R⁴_{H}, R⁵_{H}, R⁶_{H}, R⁷_{H}, R⁸_{H}, R⁹_{H}, R¹⁰_{H}, R¹¹_{H}, R¹²_{H}, R¹³_{H}, R¹⁴_{H}, R¹⁵_{H}, R¹⁶_{H}, R¹⁷_{H}, R¹⁸_{H}, R¹⁹_{H}, R²⁰_{H}, R²¹_{H}, R²²_{H}, R²³_{H}, R²⁴_{H}, R²⁵_{H}, R²⁶_{H}, R²⁷_{H}, R²⁸_{H}, R²⁹_{H}, R³⁰_{H}, R³¹_{H}, R³²_{H}, R³³_{H}, R³⁴_{H}, R³⁵_{H}, R³⁶_{H} and R^{o}_{H}, equal to or different from each other, is independently at each occurrence —H or a group of formula [group (alpha-H)]: 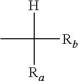
wherein Rₐ, and R_{b}, equal to or different from each other, are independently H or a hydrocarbon C₁-C₆ group;
Y, equal to or different from each other, is independently oxygen or a C₁-C₁₂ hydrocarbon group, which can be notably an aliphatic or an aromatic group, which can comprise one or more than one heteroatoms selected from N, O, S and halogens;
A^{(m-)} is an anion having valency m;
with the proviso that
(i) when salt (P) is of formula (P-1) at least two of R¹_{H}, R²_{H}, and R^{o}_{H} are groups (alpha-H);
(ii) when salt (P) is of formula (P-2) R³_{H} and R⁴_{H} are groups (alpha-H);
(iii) when salt (P) is of formula (P-3), at least two of R⁵_{H}, R⁶_{H}, R⁷_{H}, and R⁸_{H} are groups (alpha-H);
(iv) when salt (P) is of formula (P-4), at least two of R⁹_{H}, R¹⁰_{H}, R¹¹_{H}, R¹²_{H}, and R^{o}_{H} are groups (alpha-H);
(v) when salt (P) is of formula (P-5), at least two of R¹³_{H}, R¹⁴_{H}, and R^{o}_{H} are groups (alpha-H);
(vi) when salt (P) is of formula (P-6), at least two of R¹⁵_{H}, R¹⁶_{H}, R¹⁷_{H}, and R^{o}_{H} are groups (alpha-H);
(vii) when salt (P) is of formula (P-7), at least two of R¹⁸_{H}, R¹⁹_{H}, R²⁰_{H}, R²¹_{H}, and R^{o}_{H} are groups (alpha-H);
(viii) when salt (P) is of formula (P-8), at least two of R²²_{H}, R²³_{H}, R²⁴_{H}, and R^{o}_{H} are groups (alpha-H);
(ix) when salt (P) is of formula (P-9), at least two of R²⁵_{H}, R²⁶_{H}, R²⁷_{H}, and R²⁸_{H} are groups (alpha-H);
(x) when salt (P) is of formula (P-10), at least two of R²⁹_{H}, R³⁰_{H}, R^{3I}_{H}, R³²_{H}, and R²⁸_{H} are groups (alpha-H);
(xi) when salt (P) is of formula (P-11), at least two of R³³_{H}, R³⁴_{H}, and R²⁸_{H} are groups (alpha-H);
(xii) when salt (P) is of formula (P-12), at least two of R³⁵_{H}, R³⁶_{H} and R^{o}_{H} are groups (alpha-H).

2. The composition (C) according to claim 1, wherein fluoroelastomer (A) comprises at least 15 mol % of recurring units derived from VDF, with respect to all recurring units of the fluoroelastomer and/or at most 5 mol % of recurring units derived from VDF, with respect to all recurring units of the fluoroelastomer.

3. The composition (C) according to claim 1, wherein said at least one (per)fluorinated monomer different from VDF is selected in the group consisting of:
(a) C₂-C₈ perfluoroolefins;
(b) hydrogen-containing C₂-C₈ olefins different from VDF;
(c) C₂-C₈ chloro and/or bromo and/or iodo-fluoroolefins;
(d) (per)fluoroalkylvinylethers (PAVE) of formula CF₂=CFOR_{f}, wherein R_{f} is a C₁-C₆ (per)fluoroalkyl group;
(e) (per)fluoro-oxy-alkylvinylethers of formula CF₂=CFOX, wherein X is a C₁-C₁₂ ((per)fluoro)-oxyalkyl comprising catenary oxygen atoms;
(f) (per)fluorodioxoles having formula: 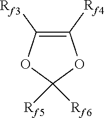
each of R_{f3}, R_{f4}, R_{f5}, R_{f6}, equal or different each other, is independently a fluorine atom, a C₁-C₆ fluoro- or per(halo)fluoroalkyl, optionally comprising one or more oxygen atom;
(g) (per)fluoro-methoxy-vinylethers (MOVE, hereinafter) having formula:
CFX₂=CX₂OCF₂OR″_{f}
wherein R″_{f} is selected among C₁-C₆ (per)fluoroalkyls, linear or branched; C₅-C₆ cyclic (per)fluoroalkyls; and C₂-C₆ (per)fluorooxyalkyls, linear or branched, comprising from 1 to 3 catenary oxygen atoms, and X₂=F, H.

4. The composition (C) according to claim 3, wherein said at least one (per)fluorinated monomer different from VDF is HFP.

5. The composition (C) according to claim 1, wherein fluoroelastomer (A) comprises one or more of:
recurring units derived from one or more than one monomer free from fluorine;
recurring units derived from at least one bis-olefin [bis-olefin (OF)] having general formula: 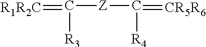
wherein R₁, R₂, R₃, R₄, R₅ and R₆, equal or different from each other, are H, a halogen, or a C₁-C₅ optionally halogenated group, possibly comprising one or more oxygen group; Z is a linear or branched C₁-C₁₈ optionally halogenated alkylene or cycloalkylene radical, optionally containing oxygen atoms, or a (per)fluoropolyoxyalkylene radical; and
recurring units derived from at least one (per)fluorinated monomer different from VDF and HFP.

6. The composition (C) according to claim 1, wherein fluoroelastomer (A) has the following monomer compositions (in mol %):
(i) vinylidene fluoride (VDF) 35-85%, hexafluoropropene (HFP) 10-45%, tetrafluoroethylene (TFE) 0-30%, perfluoroalkyl vinyl ethers (PAVE) 0-15%, bis-olefin (OF) 0-5%;
(ii) vinylidene fluoride (VDF) 50-80%, perfluoroalkyl vinyl ethers (PAVE) 5-50%, tetrafluoroethylene (TFE) 0-20%, bis-olefin (OF) 0-5%;
(iii) vinylidene fluoride (VDF) 20-30%, C₂-C₈ non-fluorinated olefins (01) 10-30%, hexafluoropropene (HFP) and/or perfluoroalkyl vinyl ethers (PAVE) 18-27%, tetrafluoroethylene (TFE) 10-30%, bis-olefin (OF) 0-5%;
(iv) tetrafluoroethylene (TFE) 45-65%, C₂-C₈ non-fluorinated olefins (01) 20-55%, vinylidene fluoride (VDF) 0.1-30%, bis-olefin (OF) 0-5%,
(v) tetrafluoroethylene (TFE) 33-75%, perfluoroalkyl vinyl ethers (PAVE) 15-45%, vinylidene fluoride (VDF) 5-30%, hexafluoropropene HFP 0-30%, bis-olefin (OF) 0-5%;
(vi) vinylidene fluoride (VDF) 35-85%, fluorovinyl ethers (MOVE) 5-40%, perfluoroalkyl vinyl ethers (PAVE) 0-30%, tetrafluoroethylene (TFE) 0-40%, hexafluoropropene (HFP) 0-30%, bis-olefin (OF) 0-5%.

7. The composition (C) according to claim 1, wherein the at least one acid (OA) comprises:
at least one aromatic ring and at least one acid group linked to said aromatic ring via a sigma bond; and/or
one electron donating group in the para-position with respect to the acid group.

8. The composition (C) according claim 7, wherein the acid group is selected from —COOH or —SO₃H.

9. The composition (C) according to claim 7 wherein the electron donating group is a C1-C5 alkyl group.

10. The composition (C) according to claim 1 wherein the at least one acid (OA) comprises at least one aromatic ring and at least one acid —SO₃H group linked to said aromatic ring via a sigma bond and one electron donating group in the para-position with respect to the acid group which is selected from —CH₃ and —CH₂CH₃.

11. The composition (C) according to claim 1, wherein said at least one acid (OA) is p-toluensulfonic acid.

12. The composition (C) according to claim 1, wherein the at least one acid (OA) is in an amount of from 0.30 to 2.10 phr based on 100 phr of fluoroelastomer (A).

13. The composition (C) according to claim 1, wherein said anion A in formulae (P-1) to (P-12) is selected from the group consisting of arylsulfonates and halides.

14. The composition (C) according to claim 1, said composition (C) further comprising:
at least one basic compound [base (B)]; and/or
one or more than one organic solvents [solvent (S)];
one or more conventional additives.

15. A method for fabricating shaped articles, comprising the use of composition (C) as defined in claim 1.

16. A cured article obtained from composition (C) as defined in claim 1.

17. The cured article according to claim 16, wherein said article is selected from pipes, joints, O-rings, and hoses.
